(19) United States
(12) Patent Application Publication
(10) Pub. No.: US 2026/0079074 A1
(43) Pub. Date: Mar. 19, 2026

(54) ESTIMATING COEFFICIENT OF DRAG

(71) Applicant: Rivian IP Holdings, LLC, Irvine, CA (US)

(72) Inventors: Kris LEACH, Tustin, CA (US); Aruna BAIJAL, Sunnyvale, CA (US); Andrew Murray MCALLISTER, Irvine, CA (US)

(21) Appl. No.: 19/330,909

(22) Filed: Sep. 17, 2025

Related U.S. Application Data
(60) Provisional application No. 63/695,800, filed on Sep. 17, 2024.

(51) Int. Cl. G01M 9/08; G06T 15/10; G06T 15/50; G06T 17/00; G06T 19/20; G06V 10/774; G06V 20/50

(52) U.S. Cl. CPC G01M 9/08; G06T 15/10; G06T 15/50; G06T 17/00; G06T 19/20; G06V 10/774; G06V 20/50; G06T 2219/2012

(57) ABSTRACT

A system receives images of a vehicle from a plurality of viewpoint locations. The system processes the images via an artificial intelligence model and outputs an estimated aerodynamic efficiency from the artificial intelligence model based on the processing. The images may include orthogonal views of the vehicle. The images may be obtained by rendering a parameterized model of the vehicle. The parameters defining the parameterized model may define an exterior shape of the vehicle. The images may be rendered with lighting, viewpoint location, and color used to generate images to train the artificial intelligence model. The artificial intelligence model may include one or more convolution layers with corresponding rectified linear units followed by a fully connected layer.

### CROSS-REFERENCE TO RELATED APPLICATIONS

This application claims priority to and benefit of U.S. Provisional Application No. 63/695,800, filed Sep. 17, 2024, which is hereby assigned to the assignee hereof and hereby expressly incorporated by reference in its entirety as if fully set forth below and for all applicable purposes.

### INTRODUCTION

The present disclosure relates to estimating a coefficient of drag.

### SUMMARY

In one aspect, a system is configured to: receive images of a vehicle from a plurality of viewpoint locations; process the images via an artificial intelligence model; and output an estimated aerodynamic efficiency from the artificial intelligence model based on the processing.

In some embodiments, the system is further configured to: receive a parameterized model of the vehicle; and render the parameterized model of the vehicle to obtain the images.

In some embodiments, the parameterized model of the vehicle is defined according to parameters defining an exterior shape of the vehicle.

In some embodiments, the system is configured to render the parameterized model of the vehicle with lighting corresponding to lighting used to generate training data used to train the artificial intelligence model.

In some embodiments, the system is configured to render the parameterized model of the vehicle from the plurality of viewpoint locations, the plurality of viewpoint locations corresponding to viewpoint locations used to generate training data to train the artificial intelligence model.

In some embodiments, the system is configured to the parameterized model of the vehicle by rendering the parameterized model of the vehicle having a color corresponding to a color used to generate training data used to train the artificial intelligence model.

In some embodiments, the artificial intelligence model includes one or more three-dimensional convolution layers followed by a fully connected layer.

In some embodiments, each three-dimensional convolution layer has a corresponding rectified linear unit.

In some embodiments, the images include six orthogonal views of the vehicle. The images may include non-orthogonal views of the vehicle.

In another aspect, a method includes receiving, by a computing system, images of a vehicle from a plurality of viewpoint locations; processing, by the computing system, the images via an artificial intelligence model; and outputting, by the computing system, an estimated aerodynamic efficiency from the artificial intelligence model based on the processing.

In some embodiments, the method further includes receiving, by the computing system, a parameterized model of the vehicle; and rendering, by the computing system, the parameterized model of the vehicle to obtain the images.

In some embodiments, the parameterized model of the vehicle is defined according to parameters defining an exterior shape of the vehicle.

In some embodiments, rendering the parameterized model of the vehicle comprises rendering the parameterized model of the vehicle with lighting corresponding to lighting used to generate training data used to train the artificial intelligence model.

In some embodiments, rendering the parameterized model of the vehicle comprises rendering the parameterized model of the vehicle from the plurality of viewpoint locations, the plurality of viewpoint locations corresponding to viewpoint locations used to generate training data to train the artificial intelligence model.

In some embodiments, rendering the parameterized model of the vehicle comprises rendering the parameterized model of the vehicle having a color corresponding to a color used to generate training data used to train the artificial intelligence model.

In some embodiments, the artificial intelligence model includes one or more three-dimensional convolution layers followed by a fully connected layer.

In some embodiments, each three-dimensional convolution layer has a corresponding rectified linear unit.

In some embodiments, the images include six orthogonal views of the vehicle.

In another aspect, a non-transitory computer-readable medium stores executable code that, when executed by one or more processing devices, causes the one or more processing devices to: receive images of a vehicle from a plurality of viewpoint locations; process the images via an artificial intelligence model; and output an estimated aerodynamic efficiency from the artificial intelligence model based on the processing.

### BRIEF DESCRIPTION OF THE DRAWINGS

FIGS. 1A to 1C illustrate example vehicle bodies in accordance with certain embodiments.

FIG. 2 illustrates a system for estimating a coefficient of drag of a vehicle in accordance with certain embodiments.

FIG. 3 is a schematic block diagram of a computing system for implementing the approach described herein in accordance with certain embodiments.

### DETAILED DESCRIPTION

Vehicle designs go through many iterations. The design of a vehicle body is based on many factors including aesthetics and a need to meet safety requirements and house vehicle requirements. The design of a vehicle preferably has a relatively low coefficient of drag (Cd) to reduce energy consumption and increase range of the vehicle. Simulating aerodynamics of a vehicle body in order to estimate Cd is a relatively long and computationally intense process. Performing a simulation to estimate Cd each time a change to a vehicle body design is considered is therefore not practical. Using the approach described herein, a machine learning model is trained to estimated Cd for a vehicle body in order to reduce the number of simulations that must be performed.

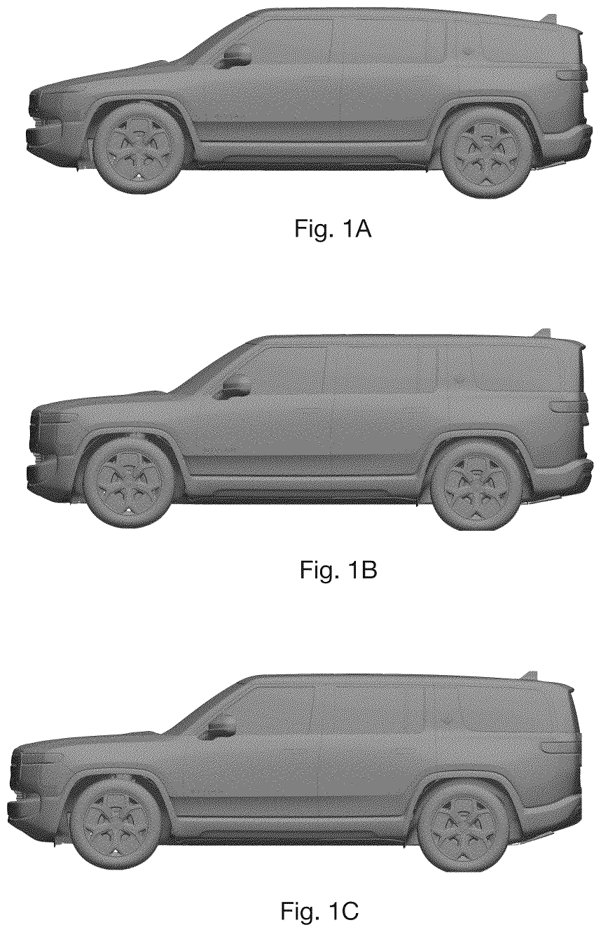

Referring to FIGS. 1A to 1C, the Cd of a vehicle contributes greatly to the energy efficiency of the vehicle. The design of a vehicle therefore will include simulating or physically testing the aerodynamic properties of the exterior of the vehicle. For example, a three-dimensional (3D) model of a vehicle may be obtained, such as from a 3D computer aided design (CAD) model or a scan of a vehicle. The 3D model may be prepared for simulation, e.g., by stitching together separate components to be modeled as a single component and cleaning up the model, e.g., by removing features that are not relevant to aerodynamics in order to reduce computational time. The prepared 3D model may then be subject to computational fluid dynamic (CFD) simulation to estimate the aerodynamic properties, such as Cd. The result of the CFD may be aerodynamic data. As used herein “aerodynamic data” may include one dimensional data (e.g., Cd) and/or 2D/3D descriptions of air flow around the vehicle, e.g., pressure on surfaces of the vehicle, regions of turbulence or laminar flow around the vehicle, or other aerodynamic data that may be used to evaluate the aerodynamic efficiency of a shape. The process of preparing the 3D model for simulation and performing the CFD simulation may take many hours and large amounts of computational resources.

Using the approach described herein, an artificial intelligence (AI) model is trained to estimate aerodynamic properties of a vehicle, such as based on images of a model of the vehicle. The model preparation and CFD simulation steps can therefore be omitted to obtain sufficiently accurate estimates of aerodynamic properties of the model. The iterative process of making changes to the model and determining the effect thereof on aerodynamics is therefore made quicker and less expensive.

The AI model may be trained using images of a 3D model of the vehicle, such as those shown in FIGS. 1A to 1C. The 3D model may be parameterized or manually modified to obtain a plurality of variations on the exterior shape thereof. The parameters that may be varied may include hood height, roof height, hood length, roof length, underbody height, hood width, roof width, body width, overall vehicle length, overall body width, wheel base length, wheel base width, wheel diameter, wheel width, hood angle, roof angle, slope of the under body between the front and front wheels of the vehicle, slope of the under body between the rear wheels and the rear of the vehicle, curvature of any panel (hood, grill, front quarter panel, rear quarter panel, roof, door, etc.), radius of curvature of corners at the transitions between panels, mirror size, mirror position, mirror shape, grille size, grille porosity, windshield rake angle, windshield curvature, belt line, side window height, side window curvature, or any other attribute known in the art to affect the aerodynamic properties of a vehicle.

The images of the 3D model may be computer generated based on the 3D model, such as a shaded rendering of the vehicle. The images may use a same color for the vehicle, with lighting from substantially (e.g., within 5% of) the same simulated location relative to a reference point of the vehicle and having substantially (e.g., within 5% of) the same intensity, color, and other characteristics. The images may be rendered from a plurality of viewpoint locations relative to the reference point. The reference point of the vehicle may be center of a wheelbase of the vehicle or other point relative to the vehicle. The plurality of viewpoint locations may include the six orthogonal views (top, bottom, left, right, front, and back). The plurality of viewpoint locations may additionally or alternatively include non-orthogonal views, such as a front-left-top viewpoint, front-right-top viewpoint, front-left-bottom viewpoint, front-right-bottom viewpoint, rear-left-top viewpoint, rear-right-top viewpoint, rear-left-bottom viewpoint, rear-right-bottom viewpoint.

The AI model may be trained with training data entries that include a set of images of a 3D vehicle model from the plurality of viewpoint locations as an input and, as a desired output, aerodynamic data obtained by simulation (e.g., CFD) or physical testing (e.g., in a wind tunnel). Aerodynamic data may be captured using substantially (e.g., within 10 per cent of nominal values) uniform testing conditions, such as air density, pressure, and relative air speed. Testing conditions may be included as part of the inputs of a training data entry. The AI model may be trained with 10 or more, 100 or more, or 1000 or more training data entries.

During utilization, a set of images of a 3D vehicle model from the plurality of viewpoint locations may be processed using the AI model to obtain estimates of aerodynamic data for the 3D vehicle model. The set of images used for training may be rendered using substantially (e.g., within 5 percent of) the same viewpoint locations, lighting location, lighting characteristics, and vehicle color as the images used for training the AI model.

In some embodiments, the training data entries are generated for a subset of possible combinations of parameter values defining the 3D vehicle model. Other combinations of parameter values for the same 3D vehicle model may then be tested using the AI model, thereby saving computational resources.

The process of designing a vehicle may therefore include:
1. Training the AI model as described above.
2. Generating a parameterized 3D model of a vehicle, such as for some or all of the parameters described above.
3. For the 3D model configured with a set of parameter values, render a set of images from the plurality of viewpoint locations.
4. Process the set of images using the AI model to obtain aerodynamic data.
5. Adjust the values of the parameters and repeat steps 3 and 4 until an acceptable aerodynamic efficiency is achieved in the context of other design constraints.

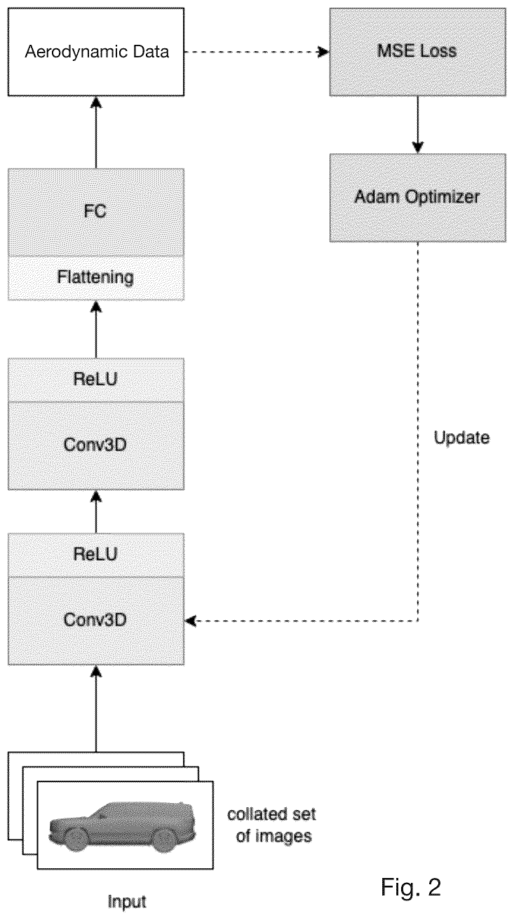

FIG. 2 illustrates an example AI architecture that may be used to implement the AI model. The set of images may be collated and input into a first 3D convolution (Conv3D) stage, the output of the first Conv3D stage is input to a first rectified linear unit (ReLU), the output of the first ReLU is input to a second Conv3D stage, the output of the second Conv3D stage is input to a second ReLU. The output of the second ReLU may be input to a flattening stage. The output of the flattening stage may be input to a fully connected (FC) layer. The output of the FC layer is the aerodynamic data, such as 1D, 2D, and/or 3D aerodynamic data.

During training, the aerodynamic data and the desired output of the training data entry from which the aerodynamic data was generated may be processed according to a loss function, such as a mean squared error (MSE) loss function. Parameters of any of the components (Conv3D, ReLU, flattening, FC) of the AI model may be updated according to the output of the loss function. For example, an optimizer, such as an Adam Optimizer may update parameters of any of the components according to the output of the loss function.

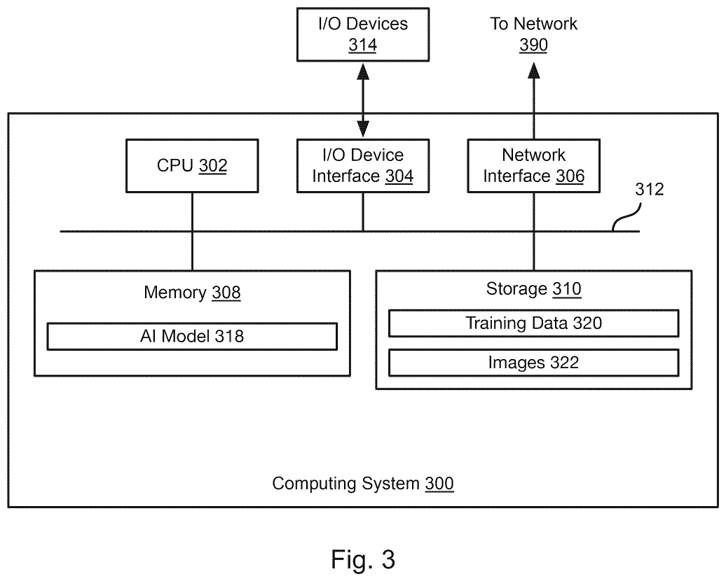

FIG. 3 illustrates an example computing system 300. The functions described above may be performed using a computing device having some or all of the attributes of the computing system 300.

As shown, computing system 300 includes a central processing unit (CPU) 302, one or more I/O device interfaces 304, which may allow for the connection of various I/O devices 314 (e.g., keyboards, displays, mouse devices, pen input, etc.) to computing system 300, network interface 306 through which computing system 300 is connected to network 390, a memory 308, storage 310, and an interconnect 312.

CPU 302 may retrieve and execute programming instructions stored in the memory 308. Similarly, CPU 302 may retrieve and store application data residing in the memory 308. The interconnect 312 transmits programming instructions and application data, among CPU 302, I/O device interface 304, network interface 306, memory 308, and storage 310. CPU 302 is included to be representative of a single CPU, multiple CPUs, a single CPU having multiple processing cores, and the like. The CPU 302 may be implemented as or work in combination with a graphics processing unit (GPU).

Memory 308 is representative of a volatile memory, such as a random access memory, and/or a nonvolatile memory, such as nonvolatile random access memory, phase change random access memory, or the like. As shown, memory 308 may store an AI model 318 as described above and software implementing interfaces for training and/or utilizing the AI model.

Storage 310 may be non-volatile memory, such as a disk drive, solid state drive, or a collection of storage devices distributed across multiple storage systems. Storage 310 may optionally store training data entries 320 for training the AI model 318 and/or sets of images 322 of a model of a vehicle for processing by the AI model 318.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative. While the foregoing is directed to embodiments of the present disclosure, other and further embodiments may be devised without departing from the basic scope thereof, and the scope thereof is determined by the claims that follow.

What is claimed is:

1. A system configured to:
receive images of a vehicle from a plurality of viewpoint locations;
process the images via an artificial intelligence model; and
output an estimated aerodynamic efficiency from the artificial intelligence model based on the processing.

2. The system of claim 1, further configured to:
receive a parameterized model of the vehicle; and
render the parameterized model of the vehicle to obtain the images.

3. The system of claim 2, wherein the parameterized model of the vehicle is defined according to parameters defining an exterior shape of the vehicle.

4. The system of claim 3, wherein the system is configured to render the parameterized model of the vehicle with lighting corresponding to lighting used to generate training data, the artificial intelligence model being trained based on the training data.

5. The system of claim 3, wherein the system is configured to render the parameterized model of the vehicle from the plurality of viewpoint locations, the plurality of viewpoint locations corresponding to viewpoint locations used to generate training data to train the artificial intelligence model.

6. The system of claim 3, wherein the system is configured to render the parameterized model of the vehicle by rendering the parameterized model of the vehicle having a color corresponding to a color used to generate training data used to train the artificial intelligence model.

7. The system of claim 1, wherein the artificial intelligence model includes one or more three-dimensional convolution layers followed by a fully connected layer.

8. The system of claim 7, wherein each three-dimensional convolution layer has a corresponding rectified linear unit.

9. The system of claim 1, wherein the images include six orthogonal views of the vehicle.

10. The system of claim 9, wherein the images include non-orthogonal views of the vehicle.

11. A method comprising:
receiving, by a computing system, images of a vehicle from a plurality of viewpoint locations;
processing, by the computing system, the images via an artificial intelligence model; and
outputting, by the computing system, an estimated aerodynamic efficiency from the artificial intelligence model based on the processing.

12. The method of claim 11, further comprising:
receiving, by the computing system, a parameterized model of the vehicle; and
rendering, by the computing system, the parameterized model of the vehicle to obtain the images.

13. The method of claim 12, wherein the parameterized model of the vehicle is defined according to parameters defining an exterior shape of the vehicle.

14. The method of claim 13, wherein rendering the parameterized model of the vehicle comprises rendering the parameterized model of the vehicle with lighting corresponding to lighting used to generate training data, the artificial intelligence model being trained based on the training data.

15. The method of claim 13, wherein rendering the parameterized model of the vehicle comprises rendering the parameterized model of the vehicle from the plurality of viewpoint locations, the plurality of viewpoint locations corresponding to viewpoint locations used to generate training data to train the artificial intelligence model.

16. The method of claim 13, wherein rendering the parameterized model of the vehicle comprises rendering the parameterized model of the vehicle having a color corresponding to a color used to generate training data used to train the artificial intelligence model.

17. The method of claim 11, wherein the artificial intelligence model includes one or more three-dimensional convolution layers followed by a fully connected layer.

18. The method of claim 17, wherein each three-dimensional convolution layer has a corresponding rectified linear unit.

19. The method of claim 11, wherein the images include six orthogonal views of the vehicle.

20. A non-transitory computer-readable medium storing executable code that, when executed by one or more processing devices, causes the one or more processing devices to:
receive images of a vehicle from a plurality of viewpoint locations;
process the images via an artificial intelligence model; and
output an estimated aerodynamic efficiency from the artificial intelligence model based on the processing.
